(19) United States
(12) Patent Application Publication
(10) Pub. No.: US 2015/0353712 A1
(43) Pub. Date: Dec. 10, 2015

(54) SUBDUEDLY COLOURED POLYCARBONATE MOULDING COMPOUNDS CONTAINING IR-REFLECTIVE PIGMENTS

(71) Applicant: BAYER MATERIALSCIENCE AG, Leverkusen (DK)

(72) Inventors: Alexander MEYER, Düsseldorf (DE); Joerg REICHENAUER, Krefeld (DE); Rafael OSER, Krefeld (DE)

(21) Appl. No.: 14/654,324

(22) PCT Filed: Dec. 18, 2013
(86) PCT No.: PCT/EP2013/077020

§ 371 Date: Jun. 19, 2015

(30) Foreign Application Priority Data
Dec. 20, 2012 (EP) 12198349.8

(51) Int. Cl. C08K 5/521; B32B 27/20; B32B 27/08; B32B 27/36; C08K 3/22; C08L 69/00

(52) U.S. Cl. CPC C08K 5/521; C08K 3/22; C08L 69/00; B32B 27/08; B32B 27/365; B32B 27/20; C08K 2003/2251; C08K 2003/2265; C08L 2201/08; C08L 2205/025; C08L 2205/06; B32B 2307/712; B32B 2307/416; B32B 2307/584; B32B 2255/26; B32B 2307/4026; B32B 2307/71; B32B 2255/10

(57) ABSTRACT

The invention relates to subduedly coloured, infrared-reflective polycarbonate moulding compounds that have high melt stability in conjunction with high reflectivity in the IR range and good weathering resistance, containing at least one IR-reflective inorganic pigment and at least one stabiliser, and further relates to the production and use of the polymer compositions as per the invention and the products thereof, in particular multilayer bodies. The invention further relates to the use of the polymer compositions as per the invention for producing roofs, panels, coverings and frames, in particular for use in buildings, motor vehicles and rail vehicles.

The invention relates to opaquely pigmented, infrared-reflective polycarbonate molding compositions with high melt stability combined with high reflectivity in the IR region and good weathering resistance, comprising at least one IR-reflective inorganic pigment and at least one stabilizer, and also to the production and use of the polymer compositions of the invention, and to the products produced therefrom, in particular multilayer structures.

The invention further relates to the use of the polymer composition of the invention for the production of roofs, panels, cladding, frames in particular for use in buildings, motor vehicles, and rail vehicles.

The polycarbonate molding compositions of the invention can moreover be used as coextrusion layers or outer layers on thermoplastics, e.g. polycarbonate or polymethyl(meth)acrylate, or as outer layer in back injection molding.

Here again, they can be used in appropriate applications, e.g. in construction applications, examples being downspouts and window frames, automobile applications such as roof modules, external and internal cladding (panels), spoilers, and mirror housings.

For the purposes of the present invention, the expression “opaquely pigmented” denotes materials which are not transparent. In particular, it denotes molding compositions with light transmittance of less than 1%.

The present invention further relates to multilayer structures comprising:

a) a substrate layer comprising
a1) at least one transparent thermoplastic polymer,
a2) at least one IR-reflective pigment selected from the group comprising:
Pigment Brown 29; chromium iron oxide; (CAS 12737-27-8) (Fe,Cr)₂O₃,
chromium oxide green chromium green black hematite (CAS 68909-79-5),
Pigment Green 50 (CAS 68186-85-6) Co/Ti/Ni/Zn oxide,
Pigment Blue 28 cobalt aluminate blue spinel (CAS 1345-16-0) and
Pigment Blue 36 cobalt chromite blue spinel (CAS 68187-11-1),
a3) at least one stabilizer, and
   b) at least one outer layer made of
b1) a transparent thermoplastic material or
b2) a transparent non-thermoplastic material.

The outer layer is preferably an SiO₂-based scratch-resistant layer.

c) The multilayer structure optionally comprises a primer layer, preferably arranged between outer layer and substrate layer.

In one preferred embodiment, the multilayer structure is composed of the layers a) and h), where the layers a) and b) are bonded directly to one another.

In another preferred embodiment, the multilayer structure is composed of the layers a), b), and c), where the arrangement has the layer c) between the layers a) and b).

For the purposes of the present invention it is also possible to combine preferred embodiments with one another.

The moldings obtained from the compositions of the invention provide many advantages over conventional materials such as glass for use in the vehicle sector. Among these are by way of example reduced risk of breakage and/or reduced weight; in the automobile sector these can provide greater safety of occupants in traffic accidents and lower fuel consumption. Finally, materials comprising thermoplastic polymers provide substantially greater design freedom because they have better moldability.

Another requirement placed upon exterior parts used in the motor vehicle sector, rail vehicle sector, and aircraft sector, or in the infrastructure sector, is that they have long lifetime, with no embrittlement and no more than minor changes to color and surface (gloss effect). Another requirement is that the thermoplastic parts have adequate scratch resistance.

Since components for the infrastructure sector or transport sector can be relatively large and can have complex geometry, the thermoplastic material is required to have adequate flowability for processing in the injection-molding process, for example specifically the injection-compression-molding process, to give appropriate moldings.

### PRIOR ART

IR-reflective compositions made of thermoplastics comprising IR-reflective pigments are in principle known.

DE 102004058083 describes opaquely pigmented compositions based on PMMA with high reflectivity in the IR region. However, these compositions are not applicable to polycarbonate, since they have inadequate melt stability.

WO 2011/144429 describes coating systems with high reflection in the IR region, preferably based on PMMA, but there is no description of the selection of the IR-reflective elements in conjunction with a stabilizer.

DE 102007061052 describes compositions made of specific colorants based on various thermoplastics; these exhibit reflection in the IR region, but the IR-reflective pigments used are not effective in polycarbonate.

The prior art does not therefore reveal which IR-reflective additives are suitable for use in polycarbonate.

WO 2010/037071 describes polymer compositions comprising titanium dioxide and other colorants, but again these pigments are not suitable for use in polycarbonate.

DE 102006029613 describes plastics composite systems made of PMMA and TPU which have high reflectivity in the IR region. However, as is also the case in DE 102004058083, these results cannot be applied to polycarbonate compositions.

EP 0548822 describes composite systems comprising compositions comprising IR-reflective particles. These composite systems comprise layers with high titanium dioxide content. The present application does not relate to these composite systems.

### Objects:

It was therefore an object of the present invention to provide polycarbonate molding compositions which exhibit high reflection in the IR region and high processing stability, and also high melt stability.

The molding compositions and components produced therefrom moreover exhibit good perceived blackness, which is demanded in many applications in the automobile sector (roofs, panels) or in the consumer electronics sector (TV frames, etc.). Particularly desirable properties are a high degree of perceived in-depth blackness and, respectively, a glass-like in-depth gloss effect,

External applications moreover require high weathering resistance.

Another object of the present invention was to provide a process for the production of multilayer thermoplastic structures with the properties described above.

Another aspect of the present invention is the economically competitive provision of IR-reflective compositions with the properties according to the invention.

The reflectance of the compositions in the IR region from above 780 to 2300 urn is at least 20%, preferably 30%.

The compositions and components moreover have low transmittance in the visible region (light transmittance), and preferably no transmittance in the visible region. These compositions are thus intended to provide opaquely pigmented structures in the finished part.

It is preferable that the TDS value is smaller than 5%, in particular smaller than 2%.

### Achievement of Object:

It has been found that compositions as claimed in claim 1 of the present invention achieve the object.

The composition of the invention comprises the following components;

a) a thermoplastic polymer, preferably based on polycarbonate, copolycarbonate, or a mixture thereof, where the quantity added of the thermoplastic polymer is such that it together with components b) to c), or b) to h) gives 100% by weight;
b) quantities of from 0.35 to 4.00% by weight, preferably from 0.4 to 3.0% by weight, and very particularly preferably from 0.5 to 2.5% by weight, of
at least one IR-reflective inorganic pigment, preferably selected from the group comprising:
Pigment Brown 29; chromium iron oxide; (CAS 12737-27-8) (Fe,Cr)₂O₃,
chromium oxide green chromium green black hematite (CAS 68909-79-5),
Pigment Green 50 (CAS 68186-85-6) Co/Ti/Ni/Zn oxide,
Pigment Blue 28 cobalt aluminate blue spinel (CAS 1345-16-0) and
Pigment Blue 36 cobalt chromite blue spinel (CAS 68187-11-1),
and also mixtures thereof;
   c) at least one stabilizer or one processing aid based on phosphate. The phosphate here has the following structure (I)

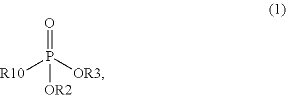

where R1 to R3 can be H, or identical or different linear, branched, or cyclic alkyl moieties. Particular preference is given to C₁- to C₁₃ alkyl moieties. C₁- to C₁₈-alkyl is by way of example methyl, ethyl, n-propyl, isopropyl, n-butyl, sec-butyl, tert-butyl, n-pentyl, 1-methylbutyl, 2-methylbutyl, 3-methylbutyl, neopentyl, 1-ethylpropyl, cyclohexyl, cyclopentyl, n-hexyl, 1,1-dimethylpropyl, 1,2-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, or 1-ethyl-2-methylpropyl, n-heptyl and n-octyl, pinacyl, adamantyl, the isomeric menthyl moieties, n-nonyl, n-decyl, n-dodecyl, n-tridecyl, n-tetradecyl, n-hexadecyl or n-octadecyl.

Examples of alkyl phosphates suitable in the invention are mono-, di-, and trihexyl phosphate, triisooctyl phosphate, and trinonyl phosphate. It is preferable to use triisooctyl phosphate (tris-2-ethylhexyl phosphate) as alkyl phosphate. It is also possible to use mixtures of various mono-, di-, and trialkyl phosphates.

The quantities used of the alkyl phosphates are less than 0.05% by weight, preferably from 0.00005% by weight to 0.05000% by weight, particularly preferably from 0.0002 to 0.05% by weight, very particularly preferably from 0.0005% by weight to 0.03% by weight, and in one very preferred case from 0.001 to 0.0120% by weight, based on the total weight of the composition.

The other components also optionally present are:

d) optionally from 0.0% by weight to 1.0% by weight, preferably from 0.01% by weight to 0.50% by weight, particularly preferably from 0.01% by weight to 0.40% by weight, of one or more mold-release agents, based on the total weight of the composition;
e) optionally from 0.0% by weight to 20.00% by weight, preferably from 0.05% by weight to 10.00% by weight, more preferably from 0.10% by weight to 1.00% by weight, still more preferably from 0.10% by weight to 0.50% by weight, and also very particularly preferably from 0.10% by weight to 0.30% by weight, of at least one or more UV absorbers, based on the total weight of the composition;
f) optionally from 0.00% by weight to 0.20% by weight of one or more heat stabilizers and/or processing stabilizers different from c), based on the total weight of the composition, preferably selected from the group of the phosphines, phosphites, and phenolic antioxidants, and also mixtures of these, where
in one specific embodiment of the present invention the quantity used of heat stabilizers and, respectively, processing stabilizers is from 0.01% by weight to 0.05% by weight, preferably from 0.015% by weight to 0.040% by weight;
g) optionally from 0.0% by weight to 5.0% by weight, preferably from 0.01% by weight to 1.00% by weight, of one or more other additives, based on the total weight of the composition,
h) optionally from 0.0% by weight to 1.0% by weight, preferably from 0.01 to 1.0% by weight, and particularly preferably from 0.02 to 0.50% by weight, of one or more colorants transparent in the IR region,

In one preferred embodiment, the composition is composed of the components a)-c), or more preferably a)-h).

In one preferred embodiment, the polymer composition is free from carbon black.

In another preferred embodiment, the polymer composition is free from TiO₂.

In another preferred embodiment, the polymer composition is free from IR absorbers, in particular inorganic IR absorbers such as lanthanum borides, tungstates and antimony-oxide-based or antimony-tin-oxide-based systems.

In one particular embodiment, the moldings obtained from the compositions of the invention are lacquered in order to achieve a glass-like in-depth gloss effect and optionally to achieve higher weathering resistance,

In one preferred embodiment, the component h) is
Pigment Brown 29; chromium iron oxide; (CAS 12737-27-8) (Fe,Cr)₂O₃,
chromium oxide green (chromium green black hematite) (CAS 68909-79-5), or
a mixture of these two pigments.

Each of the embodiments mentioned in the present description as preferred can exist individually or else in any desired combination.

The moldings obtained from the compositions of the invention have markedly higher IR reflectance than conventional dark or black compositions made of polycarbonate, which often comprise carbon black or other colorants,

The polycarbonate molding compositions of the invention and resultant moldings and components exhibit markedly less heating on insolation, while mechanical and physical properties remain good.

The composition of the invention comprises at least one specific stabilizer based on phosphate. It was surprising that specific additives based on phosphate were found to be exclusively suitable, whereas the stabilizers familiar to the person skilled in the art for polycarbonate, based on phenolic antioxidants or antioxidants based on phosphite or based on phosphine exhibited no effect.

An advantage of the compositions and components of the invention is their relatively low heat absorption in conjunction with relatively low thermal expansion; this increases precision of fit and tolerances in particular for relatively large components (frames and panels).

### Component a)

Thermoplastic materials suitable for the production of the plastics composition of the invention are polycarbonates, polyester carbonates, and polyesters. Among the polyesters, preference is given to types that inter alia are composed of the raw materials cyclohexanedimethanol and/or tetramethylcyclobutanediol. Among the polyester carbonates, preference is given to types composed of the raw materials hydroquinone and/or terephthalic acid and/or isophthalic acid. Among the polycarbonates, all of the known polycarbonates are suitable. This includes homopolycarbonates and copolycarbonates.

Rubber-modified vinyl (co)polymers and/or other elastomers are also suitable as blend constituents.

Average molar masses M̅_{w} of the suitable polycarbonates are preferably from 10 000 to 50 000 g/mol, with preference from 14 000 to 40 000 g/mol, and in particular from 16 000 to 32 000 g/mol, determined by gel permeation chromatography with polycarbonate calibration. The polycarbonates are preferably produced by the interfacial process or the melt transesterification process, these being widely described in the literature.

In relation to the interfacial process reference may be made by way of example to H. Schnell, “Chemistry and Physics of Polycarbonates”, Polymer Reviews, vol. 9, Interscience Publishers, New York 1964, pp. 33 ff., to Polymer Reviews, Vol. 10, “Condensation Polymers by Interfacial and Solution Methods”, Paul W, Morgan, Interscience Publishers, New York 1965, chapter VIII, p. 325, to Dres. U. Grigo, K. Kircher and P. R. Milder “Polycarbonate” iii Becker/Braun, Kunststoff-Handbuch [Plastics handbook], volume 3/1, Polycarbonate, Polyacetale, Polyester, Celluloseester [Polycarbonates, polyacetals, polyesters, cellulose esters], Carl Hanser Verlag Munich, Vienna, 1992, pp. 118-145, and also to EP 0 517 044 A1.

The melt transesterification process is described by way of example in Encyclopedia of Polymer Science, vol. 10 (1969), Chemistry and Physics of Polycarbonates, Polymer Reviews, H. Schnell, vol. 9, John Wiley and Sons, Inc, (1964), and also in the patents DE-B 10 31 512 and U.S. Pat. No. 6,228,973.

The polycarbonates are preferably produced via reactions of bisphenol compounds with carbonic acid compounds, in particular phosgene, or in the case of the melt esterification process diphenyl carbonate or dimethyl carbonate.

Particular preference is given here to homopolycarbonates based on bisphenol-A and copolycarbonates based on the monomers bisphenol A and 1,1-bis(4-hydroxyphenyl)-3,3,5-trimethylcyclohexane.

These and other bisphenol compounds or diol compounds that can be used for the polycarbonate synthesis are disclosed inter alia in WO 2008037364 A1 (p. 7, line 21 to p. 10, line 5), EP 1 582 549 A1 ([0018] to [0034]). WO 2002026862 A1 (p. 2, line 20 to p, 5, line 14). WO 2005113639 A1 (p. 2, line 1 to p. 7, line 20).

The polycarbonates can be linear or branched. It is also possible to use mixtures of branched and unbranched polycarbonates.

Suitable branching agents for polycarbonates are known from the literature and described by way of example in the U.S. Pat. No. 4,185,009 and DE 25 00 092 A1 (3,3-bis(4-hydroxyaryloxindoles) of the invention, see entire document in each case). DE 42 40 313 A1 (see p. 3, line 33 to 55), DE 19 943 642 A1 (see p. 5, line 25 to 34) and U.S. Pat. No. 5,367,044, and also literature cited therein.

It is moreover also possible that the polycarbonates used have intrinsic branching, and in this case no branching agent is added during the course of production of the polycarbonate. The structures known as Fries structures disclosed in EP 1 506 249 A1 for melt polycarbonates are an example of intrinsic branching,

It is moreover possible to use chain terminators during the production of the polycarbonate. Chain terminators used are preferably phenols such as phenol, alkylphenols such as cresol and 4-tert-butylphenol, chlorophenol, bromophenol, cumylphenol, or a mixture of these,

### Component b)

Component b) comprises IR-reflective pigments, and preferred pigments here are the following:
Pigment Brown 29; chromium iron oxide; (CAS 12737-27-8) (Fe,Cr)₂O₃ with density about 5.2 g/cm³ and bulk density about 0.70 g/cm³,
chromium oxide green chromium green black hematite (CAS 68909-79-5). Preferably with density 5.2 g/cm³ and with packing density 0.78 kg/L, and also pH about 8.8.
There are moreover known products with density 5.2 skin and packing density 0.77 kg/L, and also pH about 5.2, which are likewise particularly preferred.
Pigment Green 50 (CAS 68186-85-6) Co/Ti/Ni/Zn oxide,
Pigment Blue 28 cobalt aluminate blue spinel (CAS 1345-16-0) and
Pigment Blue 36 cobalt chromite blue spinel (CAS 68187-11-1),
and also mixtures thereof.

It is particularly preferable to use Pigment Brown 29, chromium iron oxide and chromium oxide green chromium green black hematite as IR-reflective pigments.

It is optionally possible to use other IR-reflective pigments such as titanium dioxide.

### Component c)

Alkyl phosphates suitable in the invention are the abovementioned alkyl phosphates, e.g. mono-, di-, and trihexyl phosphate, triisooctyl phosphate, and trinonyl phosphate. It is preferable to use triisooctyl phosphate (tris-2-ethylhexyl phosphate) as alkyl phosphate. It is also possible to use mixtures of various mono-, di-, and trialkyl phosphates,

### Component d)

The composition preferably comprises mold-release agents based on a fatty acid ester, preferably on a stearic ester, particularly preferably based on pentaerythritol.

One particular embodiment uses pentaerythritol tetrastearate (PETS) and/or glycerol monostearate (GMS).

### Component e)

The composition of the invention optionally moreover comprises an ultraviolet absorber. Ultraviolet absorbers suitable for use in the polymer composition of the invention are compounds having minimal transmittance below 400 nm and maximal transmittance above 400 nm. Compounds of this type and production thereof are known from the literature and are described by way of example in EPA 0 839 623, WO-A 96/15102, and EP-A 0 500 496. Ultraviolet absorbers particularly suitable for use in the composition of the invention are benzotriazoles, triazines, benzophenones, and/or arylated cyanoacrylates,

In one particularly preferred embodiment, the composition of the invention comprises UV absorber.

Examples of suitable ultraviolet absorbers here are the following: hydroxybenzotriazoles such as 2-(3′,5′-bis(1,1-dimethylbenzyl)-2′-hydroxyphenyl)benzotriazole (Tinuvin® 234, BASF AG, Ludwigshafen), 2-(2′-hydroxy-5′-(tert-octyl)phenyl)benzotriazole (Tinuvin® 329, BASF AG, Ludwigshafen), 2-(2′-hydroxy-3′-(2-butyl)-5′-(tert-butyl)phenyl)benzotriazole (Tinuvin® 350, BASF AG, Ludwigshafen), bis(3-(2H-benztriazolyl)-2-hydroxy-5-tert-octyl)methane, (Tinuvin® 360, BASF AG, Ludwigshafen), 2-(4,6-diphenyl-1,3,5-triazin-2-yl)-5-(hexyloxy)phenol (Tinuvin® 1577, BASF AG, Ludwigshafen), and also the benzophenones 2,4-dihydroxybenzophenone (Chimassorb® 22, BASF AG, Ludwigshafen) and 2-hydroxy-4-(octyloxy)benzophenone (Chimassorb® 81, BASF AG, Ludwigshafen), 2-propenoic acid, 2-cyano-3,3-diphenyl-, 2,2-bis[[(2-cyano′l-oxo-3,3-diphenyl-2-propenyl)oxy]methyl]-1,3-propanediyl ester (9CI) (Uvinul® 3030, BASF AG, Ludwigshafen), 2-[2-hydroxy-4-(2-ethylhexyl)oxy]phenyl-4,6-di(4-phenyl)phenyl-1,3,5-triazine (CGX UVA 006, BASF AG, Ludwigshafen), and tetraethyl 2,2′-(1,4-phenylene-dimethylidene)bismalonate (Hostavin® B-Cap, Clariant AG).

It is also possible to use mixtures of these ultraviolet absorbers.

### Component f)

In one preferred embodiment, the polymer composition moreover comprises at least one other heat stabilizer or processing stabilizer.

Compounds preferably suitable are phosphites and phosphonites, and also phosphines. Examples are triphenyl phosphite, diphenyl alkyl phosphite, phenyl dialkyl phosphite, tris(nonylphenyl)phosphite, trilauryl phosphite, trioctadecyl phosphite, distearyl pentaerythritol diphosphite, tris(2,4-di-tert butylphenyl)phosphite, diisodecyl pentaerythritol diphosphate, bis(2,4-di-tert-butylphenyl)pentaerythritol diphosphite, bis(2,4-dicumylphenyl)pentaerythritol diphosphite, bis(2,6-di-tert-butyl-4-methylphenyl)pentaerythritol diphosphite, diisodecyloxy pentaerythritol diphosphite, bis(2,4-di-tert-butyl-6-methylphenyl)pentaerythritol diphosphite, bis(2,4,6-tris(tert-butyl)phenyl)pentaerythritol diphosphite, tristearyl sorbitol triphosphite, tetrakis(2,4-di-tert-butylphenyl) 4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyldibenzo[d,g]-1,3,2-dioxaphosphocine, 2,2′,2″-nitrilo[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methylphenyl)pentaerythritol diphosphite, triphenylphosphine (TPP), trialkylphenylphosphine, bisdiphenylphosphinoethane, or a trinaphthylphosphine. It is particularly preferable to use triphenylphosphine (TPP), Irgafos® 168 (tris(2,4-di-tert-butylphenyl)phosphite), and tris(nonylphenyl)phosphite, or a mixture of these.

It is moreover possible to use phenolic antioxidants such as alkylated monophenols, alkylated thioalkylphenols, hydroquinones, and alkylated hydroquinones. It is particularly preferable to use Irganox® 1010 (pentaerythritol 3-(4-hydroxy-3,5-di-tert-butylphenyl)propionate; CAS: 6683-19-8) and Irganox 1076® (2,6-di-tert-butyl-4-(octadecanoxyecarbonylethyl)phenol).

### Component g)

The other additives are conventional polymer additives as described by way of example in EP-A 0 839 623, WO-A 96/15102, EP-A 0 500 496, or “Plastics Additives Handbook”, Hans Zweifel, 5th edition 2000, Hanser Verlag, Munich, for example flame retardants, antistatic agents, or flow improvers. The abovementioned components b) to t′) and h) are expressly excluded here.

The quantities stated above are in each ease based on the entire polymer composition.

### Component h)

Particularly suitable colorants of component h) are those based on anthraquinone, on perinone, or on phthalocyanine, or those derived from such structures. Particularly preferred colorants are described in WO 2012/080395 A1. It is moreover possible to use the following as colorants: Macrolex Violet 3R (CAS 61951-89-1; Solvent Violet 36), Macrolex Green 5B (CAS 128-80-3; Solvent Green 3; C.I. 61565), Amaplast Yellow GHS (CAS 13676-91-0; Solvent Yellow 163; C.I. 58840), Macrolex Orange 3G (CAS 6925-69-5; Solvent Orange 60; C.I. 564100), Macrolex Blue RR (CAS 32724-62-2; Solvent Blue 97; C.I. 615290); Keyplast Blue KR (CAS 116-75-6; Solvent Blue 104; C.I. 61568), Heliogen Blue types (e.g. Heliogen Blue K 6911; CAS 147-14-8; Pigment Blue 15:1; C.I. 74160), Heliogen Green types (e.g. Heliogen Green K 8730; CAS 1328-53-6; Pigment Green 7; C.I. 74260), and also Macrolex Green G (CAS 28198-05-2, Solvent Green 28; C.I. 625580),

These colorants can contribute to improvement of perceived blackness, They can improve perceived blackness, since the IR-reflective pigments often have an intrinsic color differing from black.

Colorants transparent in the IR region are preferably used in a mixture of two colorants which is often necessary in order to compensate for the intrinsic color of the IR reflective pigments.

The composition must be processable at the temperatures conventional for thermoplastics, i.e. at temperatures above 300° C., e.g. 350° C., without any significant alteration of optical properties, e.g. in-depth gloss, or of mechanical properties during processing.

The production of moldings based on the polymer composition of the invention comprising the abovementioned components uses familiar processes of incorporation via combination, mixing, and homogenization, where in particular the homogenization preferably takes place in the melt with exposure to shear forces. In a preferred method for this, polycarbonate is intimately mixed with, as appropriate, other components of the polymer molding composition, preferably of the polycarbonate molding composition, in conventional melt-mixing assemblies, e.g. in single- or multiscrew extruders or in kneaders in the melt under conventional conditions, extruded, and pelletized. The form in which the materials are added at a suitable point to the solids-conveying region of the extruder, or into the polymer melt, can either be that of separate pellets by way of weigh feeders or ancillary feed equipment, or else that of a melt at elevated temperature by means of metering pumps. Masterbatches in the form of pellets can also be combined with other particulate compounds to give a premix and then introduced together by way a feed hopper or ancillary feed equipment into the solids-conveying region of the extruder, or into the polymer melt in the extruder. It is preferable that the compounding assembly is a twin-screw extruder, particularly a twin-screw extruder with corotating screws, where the length-diameter ratio of the screw of the twin-screw extruder is preferably from 20 to 44, particularly preferably from 28 to 40. This type of twin-screw extruder comprises a homogenizing section and mixing section or a combined homogenizing and mixing section (another term used below for this “homogenizing and mixing section” being “kneading and homogenizing section”) and optionally a devolatilizing section where the absolute pressure p is preferably set at no more than 800 mbar, more preferably no more than 500 mbar, particularly preferably no more than 200 mbar. The average residence time of the mixture composition in the extruder is preferably restricted to at most 120 s, particularly at most 80 s, in particular at most 60 s. In a preferred embodiment, the temperature of the polymer melt or the polymer alloy at the extruder outlet is from 200° C. to 400° C.

In one particular embodiment, the moldings obtainable from the composition of the invention are lacquered. Preference is given here to the following layer structure:
1) At least on one side of the base layer comprising the composition of the invention, a scratch-resistant coating based on polysiloxane and comprising
   i. at least one UV absorber,
      where
   ii. the thickness of the scratch-resistant layer is from 2 to 15 μm, particularly preferably from 4.0 to 12.0 μm.
2.) Optionally, in one preferred embodiment, at least one adhesion-promoting layer (primer layer) arranged on the base layer between the base layer and the scratch-resistant layer, comprising
   i. at least one UV absorber,
      where
   ii. the thickness of the primer is from 0.3 to 8 μm, particularly preferably from 1.1 to 4.0 urn.
      In another preferred embodiment, an adhesion-promoting layer and a scratch-resistant layer have been applied on both sides of the base layer.

The process for the production of moldings from the polycarbonate compositions comprises the production of a compounded material comprising polycarbonate and the additives described above, the production of a corresponding molding, and also optionally the coating of the molding in a single- or two-stage coating process.

The design of the process for the production of a corresponding molding can be as follows:

I. Production of a compounded material made of components b) and c) and polycarbonate with

MVR from 6 cm³/(10 min) to 35 cm³/(10 min), preferably from 6 cm³/(10 min) to 25 cm³/(10 min), more preferably from 9 to 21 cm³/(10 min), in accordance with ISO 1133 (at 300° C. with 1.2 kg load), optionally comprising another heat stabilizer, and

From 0.1 to 0.5% by weight, particularly preferably from 0.2 to 0.45% by weight, of PETS.

II. Production of a molding from I. with appropriate geometry,

preferably at a mold temperature of from 60 to 150° C.,

III. Coating of the molding by the flow-molding process with a primer solution comprising

a) organic binder material that can promote adhesion between PC and a polysiloxane-based lacquer,
b) at least one UV absorber,
c) solvent,
air-drying of the component of from 10 to 60 min at room temperature and curing for from 5 min to 60 min at from 100 to 135° C.

IV. Coating of the molding by the flowcoating process with a siloxane lacquer comprising

a) organosilicon compounds of the formula R—SiX₄₋ₙ (where n is from 1 to 4), where R is aliphatic C₁- to C₁₀ moieties, preferably methyl, ethyl, propyl, isopropyl, butyl, and isobutyl, and also aryl moieties, preferably phenyl, and substituted aryl moieties, and X is H, aliphatic C₁- to C₁₀ moieties, preferably methyl, ethyl, propyl, isopropyl, butyl, and isobutyl, and also aryl moieties, preferably phenyl, substituted aryl moieties, or OH or Cl, or partial condensates of same,
b) inorganic fine-particle compound, preferably SiO₂,
c) a solvent based on alcohol,
d) at least one ITV absorber,
air-drying of the component for from 10 to 60 min at room temperature, and curing for from 10 min to 120 min at from 100 to 140° C.

The molding preferably serves for use as panels in the automobile sector, e.g. as cladding for A, B, or C columns, or as U- or O-shaped, or rectangular frame for, by way of example, glass elements in the roof region. Decorative panels are also included. The definition moreover covers intervening elements providing optical connection between glass units, and intervening elements between A-column and B-column. These moldings are also suitable for multimedia housings, e.g. TV frames. Other application sectors are found in the field of architectural glazing, examples being window frames, roof panels, and cladding for buildings.

Examples of methods that can be used in step 11 of the process to convert the compositions into the molding of the invention are spinning, blow molding, thermoforming, extrusion, injection molding, and hot pressing. Preference is given here to injection molding or injection-compression molding,

Injection-molding processes are known to the person skilled in the art and are described by way of example in “Handbuch Spritzgieβen” [injection molding handbook], Friedrich Johannaber/Walter Michaeli, Munich, Vienna: Hanser, 2001, ISBN 3-446-15632-1 or “Anleitung zum Bau von Spritzgieβwerkzeugen” [Introduction to the construction of injection molds], Menges/Michaeli/Mohren, Munich, Vienna: Hanser, 1999, ISBN 3-446-21258-2.

Injection molding here comprises all of the injection-molding processes, inclusive of multicomponent injection molding and injection-compression-molding processes.

Single- and multicomponent plastics moldings are produced by using the injection-molding and injection-compression-molding variants known in plastics processing, Conventional injection-molding processes not using injection-compression-molding technology are in particular used for the production of relatively small injection moldings where flow paths are short and operations can use moderate injection pressures. In the conventional injection-molding process, the plastics composition is injected into a cavity formed between two closed fixed mold plates, and solidifies in said cavity.

Injection-compression-molding processes differ from conventional injection-molding processes in that the injection and/or solidification procedure involves mold plate movement. In the known injection-compression-molding process, the mold plates have been somewhat opened before the injection procedure, in order to compensate for the shrinkage occurring during subsequent solidification and to reduce the injection pressure required. A pre-enlarged cavity is therefore present at the start of the injection procedure, Flash faces of the mold guarantee that the pre-enlarged cavity is sufficiently leakproof, even when the mold plates have been somewhat opened. The plastics composition is injected into said pre-enlarged cavity, and during this procedure or subsequently is subjected to pressure as the mold moves toward closure. Injection-compression-molding technology′ is more complicated, but is preferred or sometimes essential in particular in the production of moldings with large surface areas and thin walls, with long flow paths. This is the only way of reducing the injection pressures required for large moldings. Injection-compression molding can moreover avoid stresses and/or distortions in the injection molding caused by high injection pressures. This is particularly important in the production of optical plastics products such as glazing (windows) in motor vehicles, since optical plastics products have to comply with relatively stringent requirements for absence of stress.

There are various known methods for producing a scratch-resistant coating on plastics items. By way of example, it is possible to use epoxy-, acrylic-, polysiloxane-, colloidal silicagel-, or inorganic/organic-(hybrid-system)-based lacquers. These systems can by way of example be applied by way of dip-coating processes, spincoating, spray processes, or flow coating. Hardening can be achieved thermally or by means of UV irradiation. Single- or multilayer systems can be used. The scratch-resistant coating can by way of example be applied directly or after preparation of the substrate surface by using a primer. It is moreover possible to apply a scratch-resistant coating by way of plasma-assisted polymerization processes, e.g. by way of an SiO₂ plasma, Antifogging or antireflective coatings can likewise be produced by way of plasma processes. It is moreover possible to use certain injection-molding processes to apply a scratch-resistant coating to the resultant molding, an example being the in-mold-coating process involving surface-treated foils. There can be various additives present in the scratch-resistant layer, for example UV absorbers, derived by way of example from triazoles or from triazines.

To improve the adhesion of the scratch-resistant lacquer in the case of polycarbonates it is preferable to use a primer comprising UV absorber. The primer can comprise other stabilizers, e.g. HALS systems (stabilizers based on sterically hindered amines), adhesion promoters, flow aids. The respective resin can be selected from a wide variety of materials, and is by way of example described in Ullmann's Encyclopedia of Industrial Chemistry, 5^{th} Edition, vol. A18, pp. 368-426, VCH, Weinheim 1991, It is possible to use polyacrylates, polyurethanes, phenol-based systems, melamine-based systems, epoxy systems, and alkyd systems, or a mixture of these systems. The resin is mostly dissolved in suitable solvents—frequently in alcohols. The hardening can take place at room temperature or at elevated temperatures if required by the selected resin, it is preferable to use temperatures of from 50° C. to 140° C.—often after a brief period allowing removal of most of the solvent at room temperature. Examples of systems obtainable commercially are SHP470, SHP470FT, and SHP401 from Momentive Performance Materials. Coatings of this type are described by way of example in U.S. Pat. No. 6,350,512 Si, U.S. Pat. No. 5,869,185, EP 1308084, WO 2006/108520.

Scratch-resistant lacquers hard-coat materials) are preferably composed of siloxanes and preferably comprise UV absorber. They are preferably applied by way of dip-coating processes or flow processes. Hardening is achieved at temperatures of from 50° C. to 140° C., Examples of systems obtainable commercially are AS4000, SHC5020, and AS4700 from Momentive Performance Materials. Systems of this type are described by way of example in U.S. Pat. No. 5,041,313, DE 3121385, U.S. Pat. No. 5,391,795, WO 2008/109072. These materials are mostly synthesized by way of condensation of alkoxy- and/or alkylalkoxysilanes with catalysis by acid or by base. Nanoparticles can optionally be incorporated. Preferred solvents are alcohols such as butanol, isopropanol, methanol, ethanol, and mixtures of these.

Instead of primer/scratch-resistant coating combinations it is possible to use single-component hybrid systems. These are described by way of example in EP 0570165 or WO 2008/071363 or DE 2804283, Examples of hybrid systems obtainable commercially are PHC 587, PHC 587C, and UVHC 3000 from Momentive Performance Materials.

In one particularly preferred process, the lacquer is applied by way of the flow-coating process, since this process gives coated parts of high optical quality.

The flow-coating process can be carried out manually by using a hose or a suitable coating head, or automatically during passage by way of flow-coating-robot nozzles and optionally slot nozzles.

The components here can be coated either while suspended or else while carried in an appropriate rack.

In the case of relatively large and/or 31) components, the part to be coated is suspended in, or placed in, a suitable rack.

In the case of small parts, the coating can also be carried out manually. In this case, the liquid primer solution or lacquer solution that is to form the coating is poured over the sheet, starting from the upper edge of the small part, in the longitudinal direction of said sheet, while the point at which the lacquer is applied on the sheet is simultaneously moved from left to right across the width of the sheet. The lacquered sheets are air-dried and cured in accordance with the respective manufacturer's instructions while vertically suspended from a clamp.

The multilayer structures of the invention can particularly preferably be used as frames for glazing modules for automobiles, rail vehicles, and aircraft. Preference is also given to other frame parts.

The multilayer structures of the invention are suitable by way of example for black panels intended for external applications in the motor vehicle sector. These transparent elements can by way of example comprise, or frame, glass elements such as glazing or sliding roofs or headlamps. The black appearance with in-depth gloss makes the glazing area appear larger, since the roof, for example a panorama roof, appears to be made entirely of glass. Decorative, panels can also be made from this material. Also included are intervening elements providing optical connection between glass units, and intervening elements between A- and B-column in the automobile sector.

### EXAMPLES

The invention is described in more detail below with reference to embodiments, and unless otherwise stated the determination methods described here are used for all corresponding variables in the present invention.

### Melt Volume Rate:

Melt volume rate (MVR) is determined in accordance with ISO 1133, under the conditions described in the tables.

### Light Transmittance (Ty):

The transmittance measurements were made in a Lambda 900 spectral photometer from Perkin Elmer with photometer sphere in accordance with ISO 13468-2 (i.e. determination of total transmittance via measurement of diffuse transmittance and direct transmittance).

In each case 3 sample sheets were subjected to measurement, and the corresponding average value was calculated from the 3 sheets to give average surface defect rate. The measurement was made on an uncoated sample sheet.

The visible region of light (visible radiation) comprises the region with wavelength from 380 to 780 nm, and the IR region comprises the region from above 780 nm to 2300 nm,

### Determination of TDS Value (Solar Direct Transmittance) and RDS Value (Solar Direct Reflectance):

The transmittance and reflectance measurements were made in a Lambda 900 spectral photometer from Perkin Elmer with photometer sphere. All of the values were determined at wavelengths from 320 nm up to and inclusive of 2.300 nm, with Δλ of 5 nm.

“Solar Direct Transmittance” TDS and “Solar Direct Reflectance” RDS were calculated in accordance with ISO 13837, computational convention “A”.

### Perceived Blackness:

Perceived blackness is considered to be adequate if the sample has the visual appearance of blackness, it is not possible to discern the background, and the transmittance of a sample sheet of thickness 2 mm at 780 am is less than 0.01% (see above for transmittance measurement).

### Materials for Production of Test Samples:

Linear bisphenol A polycarbonate pellets having terminal groups, based on phenol with MVR 9.5 cm³/10 min, measured at 300° C. with 1.2 kg load (in accordance with ISO 1033), comprising no other additives, hereinafter termed “PC 1”,
Linear bisphenol A polycarbonate powder having terminal groups, based on phenol with MVR 6 cm³/10 min, measured at 300° C. with 1.2 kg load (in accordance with ISO 1033), comprising no other additives, hereinafter termed “PC 2”.
Linear bisphenol A polycarbonate having terminal groups, based on phenol with MVR 12 cm³/10 min, measured at 300° C. with 1.2 kg load (in accordance with ISO 1033), comprising triphenylphosphine, and also UV absorber based on benzotriazole, and mold-release agent pentaerythritol tetrastearate (CAS 115-83-3), hereinafter termed “PC 3”. PC 3 also comprises 100 ppm of triisooctyl phosphate.
Triisooctyl phosphate (tris-2-ethylhexyl phosphate; CAS 78-42-2) (OF) from Lanxess (51369 Leverkusen; Germany) was used as stabilizer of the invention based on phosphate.
Iraafos 168 (tris(2,4-di-tert-butylphenyl)phosphite; CAS 31570-04-4), and in this case the product from BASF (67056 Ludwigshafen, Germany) is used as stabilizer not of the invention.
The product Sicopal Black K 0095 from BASF′ (67056 Ludwigshafen, Germany) is used as IR-reflective pigment of the invention based on iron chromium oxide (Pigment Brown 29; CAS 12737-27-8).
The product Black 10P922 from Shepherd (B-9230 Wetteren, Belgium) is used as IR-reflective pigment of the invention based on chromium oxide green (Pigment Green 17; CAS 618909-79-5).
The product Black 30C940 from Shepherd (B-9230 Wetteren, Belgium) is used as IR-reflective pigment of the invention based on chromium oxide green (Pigment Green 17; CAS 68909-79-5).
The product Black 376A from Shepherd (B-9230 Wetteren, Belgium) is used as IR-reflective pigment not of the invention based on chromium iron nickel spinel (Pigment Black 30; CAS 71631-15-7),
The product Black 444 from Shepherd (B-9230 Wetteren, Belgium) is used as IR-reflective pigment not of the invention based on manganese ferrite spinet (Pigment Black 26; CAS 68186-94-7),

### Production of Thermoplastic Polymer Compositions Via Compounding:

The polymer composition was compounded in a ZE25 twin-screw extruder from KraussMaffei Berstorff, at a barrel temperature of 260° C. and a melt temperature of 270° C., with a rotation rate of 100 rpm and throughput 10 kWh, by using the quantities of components stated in the examples.

### Production of Test Samples:

The pellets were dried in vacuo for 5 hours at 120° C. and then processed at a melt temperature of 300° C. and a mold temperature of 90° C. in an Arburg 370 injection-molding machine with a 25 injection unit to give optical disks with diameter 80 mm and thickness 2.0 mm.

TABLE 1
Polycarbonate compositions with IR-reflective pigment

| | Example 1 | Example 2 (of | Example 3 |
|---|---|---|---|
| | (comparison) | the invention) | (comparison) |
| PC 1 | 95% by wt. | 95% by wt. | 95% by wt. |
| Sicopal Black K 0095 | 1.50% by wt. | 1.50% by wt. | 1.50% by wt. |
| PC 2 | 3.50% by wt. | 3.49% by wt. | 3.47% by wt. |
| TOF | — | 0.01% by wt. | — |
| Irgafos 168 | — | — | 0.03% by wt. |

TABLE 2
Determination of melt stability (MVR) for Examples 1 and 2

| | Example 1 | Example 2 (of | Example 3 |
|---|---|---|---|
| | (comparison) | the invention) | (comparison) |
| 300° C.; 5 min | 10.92 | 8.94 | 9.03 |
| 300° C.; 20 min | 12.95 | 9.00 | 9.72 |
| 300° C.; 30 min | 13.60 | 8.99 | 10.09 |
| 320° C.; 5 min | 21.26 | 15.38 | 16.24 |
| 320° C.; 20 min | 24.51 | 15.42 | 18.22 |
| 320° C.; 30 min | 25.50 | 15.61 | 19.62 |

The composition of the invention is seen to have higher melt stability than the comparative example, in particular at high temperatures. Surprisingly, the formulations mentioned in DE 102006029613, suitable for PMMA-based compositions, could not be applied to polycarbonate. Stabilizers conventionally used in polycarbonate, for example those based on phosphite, e.g. tris(2,4-di-tert-butylphenyl)phosphite (Irgafos 168) are surprisingly less effective.

TABLE 3
Formulations using other IR-reflective pigments

| | Example 4 | Example 5 | | |
|---|---|---|---|---|
| | of the | of the | Example 6 | Example 7 |
| | invention | invention | comparison | comparison |
| PC 3 | 95.0 | 95.0 | 95.0 | 95.0 |
| PC 2 | 4.0 | 4.0 | 4.0 | 4.0 |
| Shepherd Black | 1.0 | — | — | — |
| 10P922 | | | | |
| Shepherd Black | — | 1.0 | — | — |
| 30C940 | | | | |
| Shepherd Black | — | — | 1.0 | — |
| 376A | | | | |
| Shepherd Black | — | — | — | 1.0 |
| 444 | | | | |

TABLE 4
Optical data from Examples 2 to 7

| | Exam- | Exam- | Exam- | Exam- | Exam- |
|---|---|---|---|---|---|
| | ple 2 | ple 4 | ple 5 | ple 6 | ple 7 |
| Ty (D65 10°) | 0.0 | 0.0 | 0.0 | 0.0 | 0.0 |
| [%] | | | | | |
| RDS [%] | 20.2 | 17.6 | 18.1 | 6.2 | 10.7 |
| TDS [%] | 0.2 | 1.3 | 1.3 | 0.0 | 0.4 |

Surprisingly, it was found that the IR-reflective pigments described in DE 102004058083 or in DE 102007061052 (Example 6) as suitable in relation to IR reflection (and also described as suitable for PC) are ineffective in relation to IR reflection in polycarbonate. The same is true for pigments described as suitable in WO2010037071 (Example 7). Again, surprisingly, this type of pigment is ineffective in polycarbonate. In contrast to this, the pigment types in Examples 2, 4, and 5 exhibit good IR-reflectivity.

TABLE 5
Determination of melt stability (MVR) for Examples 4 to 7

| | Example 4 | Example 5 | Example 6 | Example 7 |
|---|---|---|---|---|
| 300° C.; 5 min | 11.624 | 11.545 | 37.269 | 12.996 |
| 300° C.; 20 min | 12.144 | 12.129 | 44.502 | 16.296 |
| 300° C.; 30 min | 12.621 | 12.300 | n.m.* | 17.877 |

*excessively low viscosity prevented measurement

Surprisingly, it is found that melt stability is markedly lower in Examples 6 and 7 than in 4 and 5. Surprisingly, stabilization proved to be ineffective here.

On the basis of the examples it can clearly be seen that stabilization is effective for some of the IR-reflective pigments, and that the corresponding pigments are therefore suitable for use in PC. The pigments specifically selected, and the stabilizer composition, were not previously known, nor could they be derived from the available prior art, it is therefore now possible to realize dark-pigmented polycarbonate compositions and, respectively, moldings therefrom with high IR reflectance.

TABLE 6
Polycarbonate composition similar to Example 2 - but
with different concentration of IR-reflective pigment

| | Example 8 | |
|---|---|---|
| | comparison | |
| PC 3 | 95.00% | by wt. |
| PC 2 | 4.97% | by wt. |
| Sicopal Black | 0.3% | by wt |
| K0095 | | |

TABLE 7
Optical properties (Example 8)

| | Example 8 |
|---|---|
| Ty (D65 10°) | 0.70 |
| [%] | |
| RDS [%] | 16.9 |
| TDS [%] | 7.1 |

Low concentration of IR-reflective pigments (Example 8) leads to relatively high TDS values (TDS>5). This was surprising, since despite the low concentration of IR-reflective pigment reflectance is similar to that in Example 2. Since energy transmission is undesirable, specific concentrations of IR-reflective pigment must be used, Other measures, e.g. use of small quantities of absorbent pigments such as carbon black or IR absorber (to reduce the TDS value), drastically reduce reflectance and are therefore unsuitable. The objects are therefore met only by the compositions of the invention with specific concentrations.

Alternatively, it is possible to achieve high reflectance values by selecting a specific multilayer structure. The plastic molding compositions of the invention with contents of less than 0.35% by weight can be used for this purpose if there is another reflective layer such as a metal layer behind said plastics layer.

Examples 9 and 10 below show that the increased reflectance values are associated with a lower surface temperature.

### Examples 9 and 10

The increase in temperature of the test samples (optical disk with diameter 80 mm and thickness 2.0 mm) was studied by irradiation with a 150 W infrared lamp (Infrared PAR 38E 150 W E27 230 V ICT; Philips; R95) arranged at a distance of 30 cm above the test sample. Surface temperature was detected by a self-adhesive sensor (arranged centrally). Ambient temperature was 22° C., with 33% relative humidity.

Initial temperature and surface temperature after 15 minutes of irradiation were detected,

| | Initial surface | Final surface |
|---|---|---|
| | temperature | temperature |
| Ex. 9 (comparison) | 22.5° C. | 73.5° C. |
| Polycarbonate comprising | | |
| 0.08% by weight of carbon | | |
| black as black pigment | | |
| Example 10 (of the invention) | 23.2° C. | 57.7° C. |
| comprising 1.0% by weight of | | |
| Sicopal Black K 0095 as black | | |
| pigment and also 0.01% by | | |
| weight of TOF | | |

The surface temperature of the test sample using a composition of the invention is seen to be markedly lower than that of the comparative example.

1.-13. (canceled)

14. A polymer composition with high IR reflectivity, comprising:
a) content of thermoplastic polymer that, with the other components, gives 100% by weight,
b) content of from 0.35 to 4.0% by weight of at least one IR-reflective pigment,
c) at least one stabilizer based on phosphate with the following structure (1) 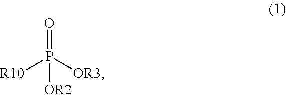
where R1 to R3 are H, or identical or different linear, branched, or cyclic alkyl moieties, where the content of c) is greater than zero and less than 0.05% by weight.

15. The composition as claimed in claim 14, wherein the composition further comprises the following components d)-h):
d) from 0.0% by weight to 1.0% by weight of one or more mold-release agents, based on the total weight of the composition,
e) from 0.0% by weight to 20.00% by weight of one or more UV absorbers, based on the total weight of the composition,
f) from 0.00% by weight to 0.20% by weight of one or more heat stabilizers and/or processing stabilizers different from c), based on the total weight of the composition,
g) from 0.0% by weight to 5.0% by weight of one or more other additives, based on the total weight of the composition,
h) from 0.0% by weight to 1.0% by weight of one or more colorants transparent in the IR region, based on the total weight of the composition.

16. The composition as claimed in claim 14, wherein the composition comprises the following contents of components b)-h), based in each case on the total weight of the composition:
b) content of from 0.4 to 3.0% by weight of at least one IR-reflective pigment,
c) content of from 0.00005% by weight to 0.05% by weight of at least one stabilizer based on phosphate,
d) from 0.01% by weight to 0.50% by weight of one or more mold-release agents, based on the total weight of the composition,
e) from 0.05% by weight to 10.00% by weight of one or more UV absorbers, based on the total weight of the composition,
f) from 0.01% by weight to 0.05% by weight of one or more heat stabilizers and/or processing stabilizers different from c), based on the total weight of the composition,
g) from 0.01% by weight to 1.00% by weight of one or more other additives, based on the total weight of the composition,
h) from 0.01% by weight to 1.00% by weight of one or more colorants transparent in the IR region, based on the total weight of the composition.

17. The composition as claimed in claim 14, wherein the thermoplastic polymer is a polycarbonate.

18. The composition as claimed in claim 14, wherein the IR-reflective pigments are selected from the group consisting of:
Pigment Brown 29; chromium iron oxide; (CAS 12737-27-8) (Fe,Cr)₂O₃,
chromium oxide green chromium green black hematite (CAS 68909-79-5),
Pigment Green 50 (CAS 68186-85-6) Co/Ti/Ni/Zn oxide,
Pigment Blue 28 cobalt aluminate blue spinel (CAS 1345-16-0) and
Pigment Blue 36 cobalt chromite blue spinel (CAS 68187-11-1).

19. The composition as claimed in claim 14, wherein the IR-reflective pigments are selected from the group consisting of:
Pigment Brown 29; chromium iron oxide; (CAS 12737-27-8) (Fe,Cr)₂O₃,
chromium oxide green chromium green black hematite (CAS 68909-79-5).

20. The composition as claimed in claim 14, wherein component c) is selected from the group comprising mono-, di-, and trihexyl phosphate, triisooctyl phosphate, and trinonyl phosphate.

21. The composition as claimed in claim 14, wherein component c) is triisooctyl phosphate.

22. A molding produced from one of the compositions as claimed in claim 14.

23. A multilayer structure comprising:
a) a substrate layer composed of the composition as claimed in claim 14,
b) at least one outer layer made of
b1) a transparent thermoplastic material or
b2) a transparent non-thermoplastic material.

24. The multilayer structure as claimed in claim 23, wherein the arrangement has an outer layer on each of the opposite sides.

25. The multilayer structure as claimed in claim 23, wherein the outer layer is directly bonded to the substrate layer.

26. The multilayer structure as claimed in claim 23, wherein the outer layer is bonded by way of a layer c) to the substrate layer.

27. The multilayer structure as claimed in claim 23, wherein the outer layer is a SiO₂-based scratch-resistant layer.

28. The multilayer structure as claimed in claim 23, wherein the base layer has been coated with a siloxane lacquer as outer layer by the flow-coating process.
